(19) United States
(12) Patent Application Publication
(10) Pub. No.: US 2025/0170592 A1
(43) Pub. Date: May 29, 2025

(54) Centrifuge With An Air Flow System

(71) Applicant: Thermo Electron LED GmbH, Osterode (DE)

(72) Inventor: Martin SCHWAGER, Osterode (DE)

(21) Appl. No.: 18/952,283

(22) Filed: Nov. 19, 2024

(30) Foreign Application Priority Data
Nov. 23, 2023 (DE) 102023132661.9

(51) Int. Cl. B04B 15/02

(52) U.S. Cl. CPC B04B 15/02

(57) ABSTRACT

Centrifuge (1) with a rotor chamber (2) containing a rotor (3) rotationally driven by a shaft (4) defining a rotational axis (R), and wherein the centrifuge (1) comprises an air inlet (21) and an air outlet (22), wherein the rotor (3) is axially arranged between the air inlet (21) and the air outlet (22), wherein a rotationally fixed air cut disc (10) is arranged within the rotor chamber (2) between the air outlet (22) and the rotor (3) and the air cut disc (10) defines an air flow channel (13) from a radially outer perimeter (12) of the air cut disc (10) radially inwardly towards a centre portion (15) of the air cut disc (10).

The present application claims priority to and the benefit of German (DE) patent application no. 102023132661.9, filed Nov. 23, 2023. All foregoing applications are incorporated herein by reference in their entireties for any and all purposes.

The invention lies in the technical field of laboratory centrifuges and particularly in the field of cooling arrangements and air guides for ventilated centrifuges.

An application for laboratory centrifuges is the separation of substances of higher and lesser density by the principle of sedimentation. Laboratory centrifuges therefore comprise rotors which have receptacles for sample containers. The sample containers are arranged in respect to a circumference of the rotor in most cases. The rotor of the centrifuge is rotationally driven around a central axis, thus exerting a centrifugal acceleration on the sample containers and the samples therein. In that way, it is possible to exert forces on the samples which are by several orders of magnitude higher than achievable under gravitational acceleration. The radial acceleration during operation of the centrifuge causes denser particles to settle outwards in a radial direction, while low-density substances are forced inwardly. The rotor rotates with a high rotational speed. Typical speeds are above 10.000 rpm. A cylindrical rotor with a diameter of 0.2 m at a rotational speed of 17.000 rpm has a circumferential velocity of around 180 m/s.

Ventilated centrifuges have an air-filled chamber, wherein the rotor rotates. The chamber is typically covered at the top with a lid. The air contained in the chamber is accelerated by the rotation of the rotor and the friction between the rotor and the contained air causes a heat-up of the rotor, the air and the samples carried by the rotor.

Such increased temperatures can lead to side reactions in the sample which may have a negative effect on further diagnostic examinations. A sample heating of less than 15 K above the environmental temperature is usually desired, so that at room temperature of 22° C., samples temperature does not exceed 37° C.

To avoid such heating, ventilated centrifuges use ambient air to cool the rotor. Air is entrained by the rotary motion of the rotor and accelerated outwardly in the radial direction towards a mostly vertical wall of a rotor chamber. Thus, a pressure gradient is created along the radial direction, i.e., from a high pressure at the rotational axis of the rotor towards a lower pressure at the circumference of the rotor and beyond. Air is drawn in from the outside through an air duct around the centre of rotation is leaving the unit through an air outlet at a point further out. The moving air is a source for acoustical noise, which needs to be reduced. The building volume of centrifuges in the radial direction is mostly constrained as preferably compact instruments are required by the users, thus there is a very limited room available in the radial direction for noise insulation measures, if the entrained and radially accelerated air is leaving the rotor chamber through openings in the vertical wall.

WO 2020 212 045 A1 shows an air inlet in the lower part of the centrifuge chamber and an outlet in the upper part. Air is drawn into the chamber via the rotor or via ventilation means. After being guided from the lower part to the upper part and having passed the chamber, the air is subsequently expelled and/or guided back to the motor in the lower part of the centrifuge. The air is guided via a multi-part air guide assembly formed from a foam material (PP or PU). The air inlet is arranged near a rotational axis and air is guided by the air guide assembly in the turning direction of the rotor.

This arrangement requires a multi-part air guide assembly with a complicated inner duct structure. The chamber is separated from the housing and insulation required to prevent the inlet air flow from heating up due to the centrifuge motor. A separation of air inlet and outlet is needed. This results in an increased space requirement as the outlet airflow needs a channel between the outer contour of the chamber and the housing.

U.S. Pat. No. 6,068,586 A concerns the cooling of a laboratory centrifuge, wherein during operation, the centrifuge is cooled by cooling air pulled in through air entry openings in the lower side of the housing and upward into the rotor chamber by the fan action created by the rotation of the rotor. The air is guided out of the rotor chamber through an air exit opening in a direction of flow tangential to the perimeter of the rotor in a manner that ensures low turbulence. In particular, a slit-like air exit opening is arranged between the casing cover and a top edge of the rotor chamber. Air is introduced via a hole in the rotor chamber and air is expelled via the slit-like opening between the lower lid cover and the top side of the housing. The introduced air gets heated by the motor. Thus, a reduced cooling performance is expected. Although a turbulence inducing lid is foreseen, the noise level is estimated to be increased due to the direct coupling of the air outlet with the rotor chamber.

DE 103 55 179 A1 shows an air-cooled centrifuge with an inlet section for the supply of air to the centrifuge vessel, a channel area arranged outside the centrifuge vessel for expelling air from the centrifuge and a duct area for the removal of air from the centrifuge vessel, wherein a diffusor is arranged at least upstream of the channel area. DE 103 55 179 A1 shows in particular a diffusor element at the upper edge of the centrifuge vessel. The diffusor element spans to about a quarter of the circumference and guides air towards an air outlet at the lower portion of the centrifuge chamber. Air is guided into the centrifuge via over openings in the lower lid cover and air is expelled from the centrifuge via a gap between the top edge of the chamber and the desk plate of the housing. An air guiding device includes a diffusor at the beginning of the air outlet channel. This is an expensive construction and requires space radially due to additional parts and because the outlet airflow needs a channel between the outer contour of the chamber and the housing.

U.S. Pat. No. 5,490,830 A shows a centrifuge which is cooled via a fan drawing air through a centrifuge housing having an internal configuration for providing for an air flow onto and around the outside of a sealed rotor chamber. The fan draws air through an inlet into a lower portion of the housing which is separated from an upper portion of the housing via a baffle plate which mates with the walls of the centrifuge housing except for a gap at a front wall of the housing. A drive motor is positioned in the baffle plate so that cooling air is drawn through the motor into the upper portion as well as around it in the lower portion of the centrifuge housing. The airflow generated by fans is directed onto and around the rotor chamber. The air inlet and outlet are arranged in the back panel of the centrifuge. This arrangement is expensive due to additional fans required the produce the airflow. Also, there is a space requirement because the air needs space to flow around the rotor chamber. The problem to be solved is to foresee a compact, efficient, and silent air guide arrangement for cooling samples and/or downstream cooling of a centrifuge drive within a ventilated centrifuge with a reduced noise level.

The invention described herein is associated with the definition of an air flow channel within a rotor chamber of a ventilated centrifuge according to claim 1.

The invention pertains to a centrifuge preferably to a ventilated centrifuge with a rotor chamber containing a rotor rotationally driven by a shaft defining a rotational axis, and wherein the centrifuge comprises an air inlet and an air outlet, wherein the rotor is axially arranged between the air inlet and the air outlet, whereby the invention foresees that a rotationally fixed air cut disc is arranged within the rotor chamber between the air outlet and the rotor and the air cut disc defines an air flow channel from a radially outer perimeter of the air cut disc radially inwardly towards a centre portion of the air cut disc.

By means of the air flow channel, air is guided through the rotor chamber from the air inlet to the air outlet. The air flow channel is a defined path wherein the air is guided. The air cut disc serves as a separation of the air flow within the air flow channel and the rotating rotor. The rotation of the rotor forces the air to flow radially outward to a radial wall of the rotor chamber. The air cut disc generates a flow separation from this radial outward acceleration, which is predominantly caused by friction of the entrained air with the rotor, and thus allows the air to flow radially inward towards a centre portion of the air cut disc and subsequently to the air outlet of the centrifuge. In that way, the air throughput is increased, and thus allowing for a better cooling performance. An additional benefit lies in that the noise emission of the centrifuge is reduced with such an air cut disc.

According to a further aspect of the invention, the air cut disc may be concentrically arranged with the rotational axis. Such an arrangement contributes to the overall symmetry of the system and has proven to be beneficial for flow in the air guide channel defined by the air guide disc. By using a concentrical arrangement, congestion of the radially outwardly accelerated air by the rotor in the rotor chamber is further reduced, which contributes further to the above-mentioned benefits of an increased cooling performance and noise reduction.

In a further aspect of the invention, it is foreseen that the air cut disc may have one or more one air baffles for deflecting air. The air within the rotor chamber is not only picked up by its friction at the interface with the rotating rotor of the centrifuge and thus forced radially outwardly, the air picked up by the rotor will also have a movement component in the rotation direction of the rotor. The air baffles may pick up the air with this component and help to deflect it into a radially inward direction within the air flow channel. Preferably, the air cut disc may extend radially from the rotational axis and the one or more one air baffles may be axial protrusions in respect to the rotational axis and the air baffles may protrude from the air cut disc towards the air outlet. Optionally, the one or more one air baffles may be formed integrally with the air cut disc.

According to a further aspect of the invention, the one or more one air baffles may have a chamfer or a radius between the air cut disc and their axial protrusion. Such a radius or chamfer serves as a smooth transition, especially if the air cut disc is a disc protruding predominantly in the radial direction and the air baffles essentially protrude perpendicularly in an axial direction. Air turbulences are reduced, which contributes to an improved flow of air and the reduction of associated noise.

In a further aspect of the invention, it is foreseen that the one or more one air baffles may extend in an arcuate manner from a centre portion of the air cut disc to an outer perimeter of the air cut disc. Preferably, but not exclusively, the arc is embodied so as to be open against the rotational direction of the rotor. In a further aspect of the invention, it is foreseen that the one or more air baffles may be concavely shaped against the rotation direction of the rotor. This does beneficially support the entrainment of the air accelerated by the rotor within the air flow channel. According to another aspect of the invention and leading to the same benefits, the one or more one air baffles may be in a spiral arrangement. The air entrainment may be further improved by another aspect of the invention, according to which the air baffles may be tangential to an outer perimeter of the air cut disc and, wherein the air baffles may further prescribe a circular arc toward the centre portion of the air cut disc, preferably open against the rotational direction of the rotor.

In a further aspect of the invention, it is foreseen that the air cut disc may have a centre portion which is offset from an outer portion in an axial direction. This axial offset or cranked embodiment of the air cut disc may serve to increase the cross section of the air flow channel defined by the air cut disc and is thus beneficial for the air throughput and the reduction of noise emissions, as the rate of the air flowing through the air flow channel is decreased in relation to the cross-sectional area of the air flow channel.

According to another aspect of the invention, the one or more air baffles may have engagement features for a torque-proof connection of the air cut disc with the rotor chamber. In that way, the air cut disc is maintained in a rotationally locked position in relation to the rotor, wherein the benefits mentioned above are not reduced to a partial entrainment of the air cut disc into the rotational movement of the centrifuge rotor.

In a further aspect of the invention, it is foreseen that the air cut disc may have a through-opening arranged at the centre portion of the air cut disc and the through-opening may be configured to feed through a shaft of the centrifuge. This arrangement significantly improves the construction of a centrifuge with an air cut disc defining an air flow channel in a rotor chamber, especially, if according to a further aspect of the invention, the rotor chamber may be upwardly open, and a chamber top may be covered by a lid, and the air inlet may be arranged in the lid. Particularly if it is foreseen that the air outlet may be arranged in a bottom portion of the chamber. According to another aspect of the invention, the air cut disc may be arranged between the bottom portion of the rotor chamber and the rotor, wherein the air inlet may be arranged in the lid of the centrifuge and the air outlet is arranged in the bottom portion of the rotor chamber. Essentially, the air cut disc may in that way be arranged between an air outlet arranged in a bottom of a bowl-shaped rotor chamber and the rotor of the centrifuge, wherein the rotor is driven by a shaft extending through the rotor chamber bottom and the air cut disc. The bowl-shaped rotor chamber is closed off at its upward opening by a lid, wherein the lid has an air inlet. The air is thus accelerated by the rotor towards the radial walls of the rotor chamber and further guided through the air flow channel defined by the air cut disc and the bottom of the rotor chamber. New air is forced into the rotor chamber through the air inlet and the pressure difference created by the radial acceleration of the air entrained within the rotor chamber. The air cut disc serves to separate the forced radial outward air flow by the rotor rotation and the friction between the rotor and the air from an air flow within the air flow channel, which is directed radially inwardly towards the air outlet in the bottom of the rotor chamber.

According to another aspect of the invention, the air inlet and/or the air outlet may be in concentric arrangement with the rotational axis. This further contributes to an efficient air exchange, as the pressure minimum is approximately in the centre of rotation, so that the air is efficiently taken in through the air inlet and the rotationally agitated air is also efficiently guided radially inwardly to its centre of rotation without any significant losses in rate of the air flow or generation of unnecessary turbulences.

Consequently, and under maintenance of the benefits mentioned above, it is foreseen in a further aspect of the invention that the air inlet, the air outlet, the rotor, the rotor chamber and the air cut disc may form an air flow path from the air inlet, through a gap between the rotor outer perimeter and axial walls of the rotor chamber over the air flow channel defined by the air cut disc to the air outlet. According to a further aspect of the invention, the air cut disc may separate the radially inwardly guided air between the air cut disc and the bottom portion of the chamber from the rotor, and in particular from a face of the rotor facing the bottom portion of the chamber. The air cut disc thus serves as a separation of the air flow within the air flow channel and the rotating rotor and separates the radially inward air flow in the air flow channel to the air outlet from any radially outward air flow caused by picked up air by the rotor being in rotation during the operation of the centrifuge.

In a further aspect of the invention, it is foreseen that an outer perimeter of the air cut disc may correspond to a lower outer rotation perimeter of the rotor, which improves the air intake into the air flow channel defined by the air cut disc.

According to another aspect of the invention, the air cut disc may guide the air flow axially downward towards the air outlet, and in a further aspect of the invention, it is foreseen that the one or more one air baffles may extend radially outwardly beyond a radially outer periphery of the air outlet, and/or the one or more one air baffles may extend radially inwardly beyond a radially outer periphery of the air outlet. In that way, the air guidance towards the air outlet is further improved.

In a further aspect of the invention, it is foreseen that the air inlet may have a smaller diameter than the air outlet. Such a dimensioning further improves the efficiency of the air exchange, as it is maintained that the air outlet does not constitute a bottleneck. In that way, any excess pressure buildup between the periphery of the rotor and the radial wall of the rotor chamber is avoided.

According to another aspect of the invention, the air outlet may lie on a perimeter with respect to the rotor chamber, wherein this perimeter may be smaller than the rotation perimeter of the rotor. In a further aspect of the invention, it is foreseen that the air outlet may be an annular opening which may be radially outwardly limited by the rotor chamber and radially inwardly limited by a shaft casing of the centrifuge. According to a further aspect of the invention, the air cut disc may protrude radially between the bottom portion of the chamber and the rotor. In a further aspect of the invention, it is foreseen that the air cut disc may be in axial contact with the shaft casing of the centrifuge. By use of such a design, constructive advantages arise in respect of the through pass of the rotor shaft and any bearing against the rotor housing, while maintaining a sufficiently large air outlet for an efficient discharge of the air from the rotor chamber.

In a further aspect of the invention, it is foreseen that the air may be guided through the air outlet of the rotor chamber and may be further guided around the motor and may exit the centrifuge through an exit aperture. In that way, the air, which gets inadvertently drawn into the rotor chamber of the ventilated centrifuge may also serve for cooling purposes of the motor. By guiding the air through the air guide and then to the air outlet to the motor, it is maintained that the motor does not pre-heat the air drawn into the air inlet.

According to a further aspect of the invention, the air cut disc may be arranged between the rotor and the lid, wherein the air inlet may be arranged in the bottom portion of the rotor chamber and the air outlet may be arranged in the lid of the centrifuge. Such a design may have advantages in certain applications, where it is for constructive or for analysis reasons not possible to introduce the ventilation air of a ventilated centrifuge from the side of the lid.

It will be apparent to a person skilled in the art that the air cut disc as described in the various embodiments above may also constitute an independent device for improving the air flow within existing ventilated centrifuges.

The invention will now be described in relation to the following non-limiting figures. Further advantages of the disclosure are apparent by reference to the detailed description when considered in conjunction with the figures in which:

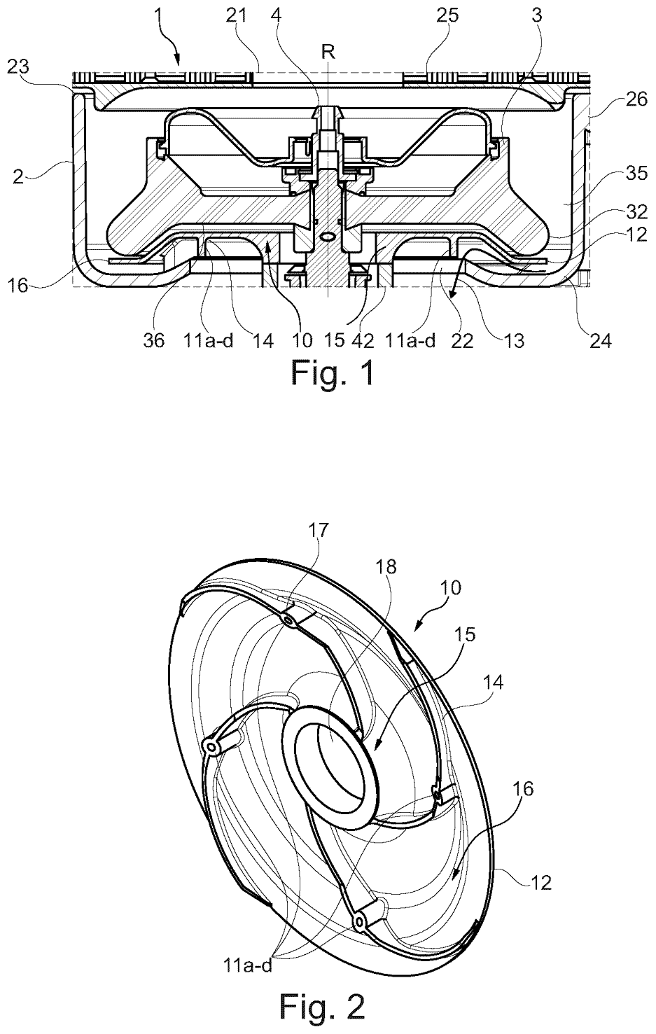

FIG. 1 shows a schematical cross section through a rotor chamber of a ventilated centrifuge,

FIG. 2 shows a perspective view of an air cut disc,

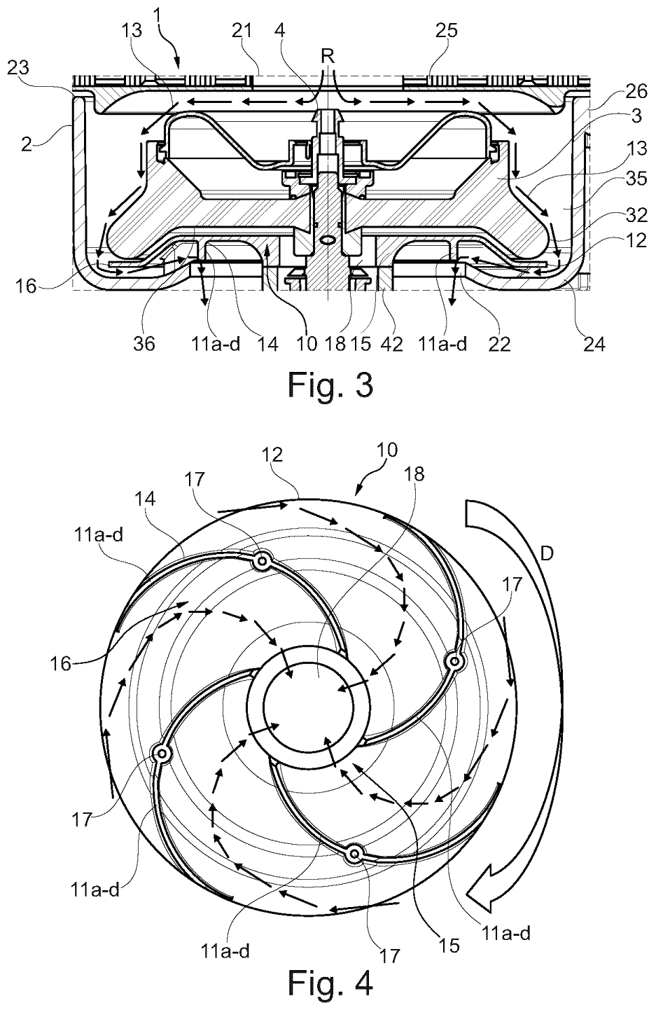

FIG. 3 shows an air flow path with respect to the schematical cross section through a rotor chamber of a ventilated centrifuge according to FIG. 1, and

FIG. 4 shows the air flow path through an air flow channel at least partially defined by the air cut disc in a bottom view of the air cut disc.

FIG. 1 shows a section of a centrifuge 1 with a rotor chamber 2, wherein the rotor chamber 2 contains a rotor 3 rotationally driven by a shaft 4 defining a rotational axis R. The centrifuge 1 comprises an air inlet 21 to the rotor chamber 2 and an air outlet 22 from the rotor chamber 2.

The rotor 3 is arranged axially between the air inlet 21 and the air outlet 22, and a rotationally fixed air cut disc 10 is arranged within the rotor chamber 2 between the air outlet 22 and the rotor 3. The air cut disc 10 is concentrically arranged with the rotational axis R and an outer perimeter 12 of the air cut disc 10 corresponds to lower outer rotation perimeter 32 of the rotor.

The rotor chamber 2 is upwardly open, and a chamber top 23 is covered by a lid 25, and the air inlet 21 is arranged in the lid 25. The rotor chamber 2 is bowl-shaped and the air outlet 22 is arranged in a bottom portion 24 of the chamber 2. The air inlet 21 and the air outlet 22 are in concentric arrangement with the rotational axis R, as well as with the rotor 3 and the air cut disc 10.

The air cut disc 10 is in axial contact with a shaft casing 42 of the centrifuge and protrudes radially between the bottom portion 24 of the chamber 2 and the rotor 3.

Now with reference to FIGS. 2 and 4, the air cut disc 10 defines an air flow channel 13 from a radially outer perimeter 12 of the air cut disc 10 radially inwardly towards a centre portion 15 of the air cut disc 10. The air flow channel 13 is also constituted by several air baffles 11a-d embodied as protrusions in respect to the rotational axis R, protruding axially from the radially extending air cut disc 10. The air baffles 11a-d are integrally formed with the air cut disc 10 and have a chamfer or a radius 14 between the air cut disc 10 and their axial protrusion.

The air baffles 11a-d extend in an arcuate manner from a centre 15 of the air cut disc 10 to an outer perimeter 12 of the air cut disc, more specifically and as can be seen from FIGS. 2 and 4, the air baffles 11a-d are tangential to the outer perimeter 12 of the air cut disc 10 and are in a spiral arrangement and opened against the rotation direction D of the rotor 3. The air baffles 11a-d have engagement features 17, here embodied as receptacles for bolts, for a torque-proof connection of the air cut disc 10 with the rotor chamber 2. The centre portion 15 of the air cut disc 10 is offset from an outer portion 16 of the air cut disc 10 in an axial direction. The centre 15 of the air cut disc 10 has a through-opening 18, which is, as can best be seen in FIGS. 1 and 3, configured to feed through the shaft 4 of the centrifuge 11.

As can best be seen from FIGS. 3 and 4, the air inlet 21, the air outlet 22, the rotor 3 the rotor chamber 2 and the air cut disc 10 form an air flow path 6 from the air inlet 22, through a gap 35 between the rotor 3 outer perimeter 32 and the axially extending wall 26 of the rotor chamber 2 and further over the air flow channel 13 to the air outlet 22.

The air cut disc 10 separates the radially inwardly guided air between the air cut disc 10 and the bottom portion 24 of the rotor chamber 2 from the rotor 3, and in particular from a face 36 of the rotor 3 facing the bottom portion 24 of the chamber 2.

As can be further seen from FIG. 3, the air cut disc 10 guides the air flow axially downward towards the air outlet 22 and the air baffles 11a-d extend both radially outwardly and radially inwardly beyond the air outlet 22. As can further be seen from FIG. 3, the air inlet 21 has a smaller diameter than the air outlet 22 and the air inlet 21 has also a resulting cross-sectional area which is smaller than the cross-sectional area of the air outlet 22, although the air outlet 22 is embodied as an annular opening, which is radially outwardly limited by the rotor chamber 2 and radially inwardly limited by the shaft casing 42 of the centrifuge 1.

As it becomes apparent from FIG. 3, the air is guided through the air outlet 22 of the rotor chamber 2 and may thus be further guided around a motor of the centrifuge and may exit the centrifuge 1 through an exit aperture, whereas both the motor and the exit aperture of the centrifuge 1 are not shown in the drawings.

It will be appreciated that the present disclosure is not limited to the embodiments described above and that modifications and variations on the embodiments described above will be readily apparent to the skilled person.

It is for example possible to foresee that the air cut disc is arranged between the rotor and the lid, wherein the air inlet is arranged in the bottom portion of the rotor chamber and the air outlet is arranged in the lid of the centrifuge. The air flow path would then be from the bottom of the rotor chamber, through the gap between the axial wall of the rotor chamber and then guided by the air cut disc in the air guide channel between the air cut disc and the lid. Such an embodiment might have advantages in certain applications, where it is for constructive or for analysis reasons not possible to introduce the ventilation air of a ventilated centrifuge from the side of the lid.

Features of the embodiments described above may be combined in any suitable combination with features of other embodiments described above as would be readily apparent to the skilled person and the specific combinations of features described in the above embodiments should not be understood to be limiting.

### LIST OF REFERENCE SIGNS

1 Centrifuge
2 Rotor chamber
3 Rotor
4 Shaft
10 Air cut disc
11a-d Air baffles
12 Outer perimeter (of the air cut disc)
13 Air flow channel
14 Chamfer, Radius
15 Centre portion (of the air cut disc)
16 Outer portion (of the air cut disc)
17 Engagement features
18 Through-opening
21 Air inlet
22 Air outlet
23 Chamber top
24 Bottom portion
25 Lid
26 Axial wall
32 Outer rotation perimeter (of the rotor)
35 Gap
36 Face (of the rotor)
42 Shaft casing
R Rotational axis
D Rotation direction

1. A centrifuge (1) with a rotor chamber (2) containing a rotor (3) rotationally driven by a shaft (4) defining a rotational axis (R), and wherein the centrifuge (1) comprises: an air inlet (21) and an air outlet (22), wherein the rotor (3) is axially arranged between the air inlet (21) and the air outlet (22), characterized in that a rotationally fixed air cut disc (10) is arranged within the rotor chamber (2) between the air outlet (22) and the rotor (3) and the air cut disc (10) defines an air flow channel (13) from a radially outer perimeter (12) of the air cut disc (10) radially inwardly towards a centre portion (15) of the air cut disc (10).

2. The centrifuge (1) according to claim 1, wherein the air cut disc (10) is concentrically arranged with the rotational axis (R) and the air cut disc (1) has one or more one air baffles (11a-d) for deflecting air.

3. The centrifuge (1) according to claim 2, wherein the one or more one air baffles (11a-d) are in a spiral arrangement, and the one or more the air baffles (11a-d) are tangential to an outer perimeter of the air cut disc (10).

4. The centrifuge (1) according to claim 2, wherein the one or more one air baffles (11a-d) have engagement features (17) for a torque-proof connection of the air cut disc (10) with the rotor chamber (2).

5. The centrifuge (1) according to claim 1, wherein the air cut disc (10) has a through-opening (18) arranged at the centre portion (15) of the air cut disc (10) and the through-opening (18) is configured to feed through the shaft (4) of the centrifuge (1).

6. The centrifuge (1) according to claim 1, wherein the air inlet (21) and/or the air outlet (22) are in concentric arrangement with the rotational axis (R).

7. The centrifuge (1) according to claim 1, wherein the air inlet (21), the air outlet (22), the rotor (3), the rotor chamber (2) and the air cut disc (10) form an air flow path from the air inlet (21) arranged in a lid (25) of the centrifuge (1), through a gap (35) between the rotor outer perimeter (32) and an axial wall (26) of the rotor chamber (2) over the air flow channel (13) defined by the air cut disc (10) to the air outlet (22) arranged in a bottom portion (24) of the rotor chamber (2).

8. The centrifuge (1) according to claim 1, wherein the air cut disc (10) separates the radially inwardly guided air between the air cut disc (10) and the bottom portion (24) of the chamber (2) from the rotor (3).

9. The centrifuge (1) according to claim 1, wherein an outer perimeter (12) of the air cut disc (10) corresponds to a lower outer rotation perimeter (32) of the rotor (3).

10. The centrifuge (1) according to claim 1, wherein the air outlet (22) lies on a perimeter with respect to the rotor chamber (2), wherein this perimeter is smaller than the rotation perimeter (32) of the rotor (3).

11. The centrifuge (1) according to claim 1, wherein the air outlet (22) is an annular opening which is radially outwardly limited by the rotor chamber (2) and radially inwardly limited by a shaft casing (42) of the centrifuge (1).

12. The centrifuge (1) according to claim 1, wherein the air cut disc (10) protrudes radially between the between the bottom portion (24) of the rotor chamber (2) and the rotor (3).

13. The centrifuge (1) according to claim 1, wherein the air cut disc (10) is in axial contact with the shaft casing (42) of the centrifuge (1).

14. The centrifuge (1) according to claim 1, wherein the air is guided through the air outlet (22) of the rotor chamber (2) is further guided around a motor of the centrifuge (1) and exits the centrifuge (1) through an exit aperture.

15. The centrifuge (1) according to claim 1, wherein the air cut disc (10) is arranged between the rotor (3) and the lid (25), wherein the air inlet (21) is arranged in the bottom portion (24) of the rotor chamber (2) and the air outlet (22) is arranged in the lid (25) of the centrifuge (1).
